(19) United States
(12) Patent Application Publication
(10) Pub. No.: US 2019/0227857 A1
(43) Pub. Date: Jul. 25, 2019

(54) SMART CLIPBOARD FOR SECURE DATA TRANSFER

(71) Applicant: salesforce com, inc, San Francisco, CA (US)

(72) Inventor: Wojciech A. Koszek, Menlo Park, CA (US)

(21) Appl. No.: 15/880,437

(22) Filed: Jan. 25, 2018

(51) Int. Cl. G06F 9/54; G06F 21/62

(52) U.S. Cl. CPC G06F 9/543; G06F 21/6209; G06F 9/544

(57) ABSTRACT

Embodiments regard a smart clipboard for secure data transfer. An embodiment of a smart clipboard apparatus includes a memory including a clipboard buffer, the clipboard buffer including storage of clipboard data and storage of clipboard metadata associated with the clipboard data; and a processor to process data and metadata for the clipboard buffer. Upon receiving an indication of a request from a user to copy a set of data from a first location in a source, the apparatus stores the set of data and a set of metadata associated with the set of data in the clipboard buffer, the set of metadata including security information for the set of data; and, upon receiving an indication of a request from the user to paste the set of data to a second location in a destination, the apparatus uses the set of metadata to determine whether to permit pasting of the set of data to the second location based at least in part on the security information for the set of data and information for the destination.

### TECHNICAL FIELD

Embodiments relate to techniques for computer operation. More particularly, embodiments relate to a smart clipboard for secure data transfer.

### BACKGROUND

In computer operations, the clipboard function has existed for many years, whereby data to be copied, such as from a first location to a second location in an application, or from the first application to a second location in a second application, is stored in a temporary location, such as a reserved section of computer memory, the reserved section of memory generally be a section of random access memory (RAM). The data from the clipboard is then copied (pasted) to the second location.

However, work processes and applications have changed greatly over the years. A user may now be working in a computer system with many windows open, or may be operating in a collaborative application environment in which many different people with different roles and security permissions are involved. The user may be, for example, working with engineering, sales, and customers in various applications at same time. The user may also be working from home, and accessing both business and personal information.

In such a working environment, it is easily possible to transfer data utilizing the clipboard function to a wrong person or wrong application. Further, even if a copy operation is directed to the intended recipient, it is also possible to mistakenly copy the wrong item from a clipboard that can contain multiple items.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is an illustration of smart chipboard operation according to some embodiments;

FIG. 2 is an illustration of a smart clipboard mechanism according to some embodiments;

FIG. 3 is an illustration of a split clipboard buffer of a smart clipboard mechanism or process according to some embodiments;

FIG. 4A is a flowchart to illustrate a smart clipboard process for secure data access control according to some embodiments;

FIG. 4B is a flowchart to illustrate a smart clipboard process for data handling control according to some embodiments;

FIG. 5 illustrates a block diagram of an environment wherein an on-demand database service might be used; and

FIG. 6 illustrates details of an environment wherein an on-demand database service might be used.

### DETAILED DESCRIPTION

In the following description, numerous specific details are set forth. However, embodiments may be practiced without these specific details. In other instances, well-known circuits, structures and techniques have not been shown in detail in order not to obscure the understanding of this description.

In a computing environment, an apparatus, system or process provides a smart clipboard for secure data transfer. In some embodiments, the smart clipboard provides storage of certain metadata (which may be referred to herein as clipboard metadata) together with the data to be copied (which may be referred to as clipboard data), instead of only the data itself as in conventional implementations. In some embodiments, in an operation to copy and paste data from a first location in a source (such as a first file and first application) to a second location in a destination (such as a same or different file and application), the clipboard metadata is utilized to determine whether and how the clipboard data is pasted into a second location.

As used herein, the operation commonly referred to as cutting of data (copying data from a first location and removing the data from the first location) is included as a copy operation, i.e., a copy operation includes both an operation in which the original data remains in the first location upon copying to a second location and an operation in which the original data is removed from the first location upon copying to the second location.

In some embodiments, a smart clipboard operates within the common and well-known copy/cut and paste function in, for example, a word processing, graphics, document production, or other related application, thus enabling a seamless operation for a user within such an application if there are no security issues or other issues involved in the paste operation.

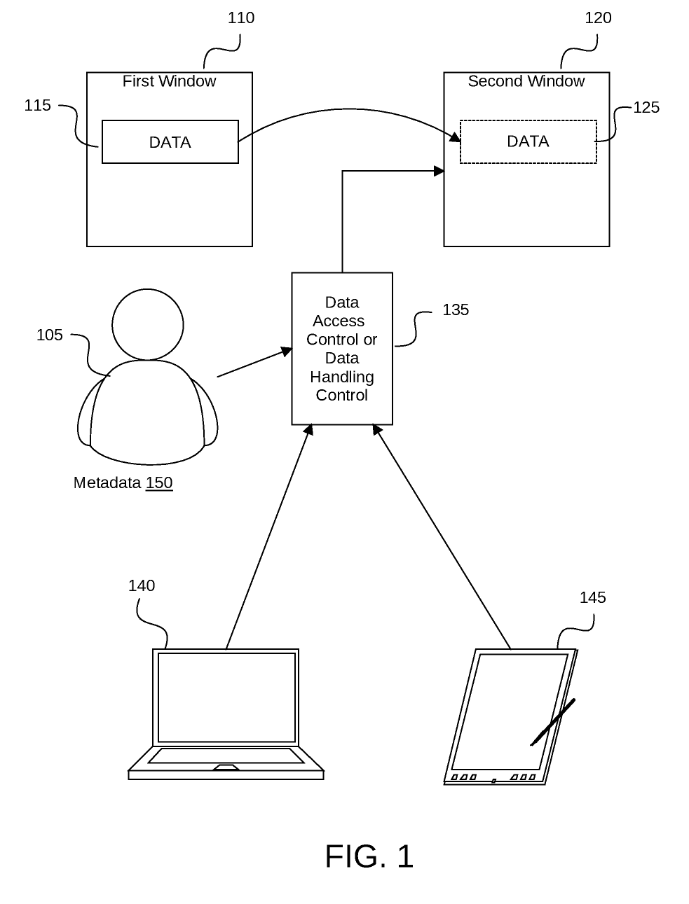

FIG. 1 is an illustration of smart chipboard operation according to some embodiments. In some embodiments, a user 105 utilizing a computing system, such as the illustrated laptop computer 140 or tablet computer 145, requests a copy (which may be either a copy or cut of data) and paste operation. As illustrated in FIG. 1, the request includes a request to copy data from a first location 115 in a first window (or other view) 110 from a source, and to paste such clipboard data to, for example, a second location 125 in a second window 120 in an intended destination. In one example, the first window 110 may be a window for a first document or other file in a first application, and the second window may be a window for a second document or other file in the same first application, or a different second application. The clipboard data may include text, a graphical operation, a numerical figure, or other data element that may be copied between locations.

However, the particular circumstances of the copy and paste operation may create issues regarding the copying of the clipboard data in the first location 115 from the first window 110 to the second window 120. For example, the second window 120 may represent a file that is accessible to a different set of users than the first window 110, and thus there may be security concerns regarding the copy operation. In a specific example, the user 105 may be unaware that the data in the first location 115 should not be provided to certain users who have access to the file in the second window 120, or may mistakenly copy incorrect data to the second window, thus creating a security risk in the copy and paste operation.

Further, the file represented by the second window may utilize the data in a particular way depending on the nature of the data, the identity of the user (where metadata may include user name, user gender, and other user information), or other factors (such as source system information, which may include software version, operating system for source, and other information). For example, an application may perform a particular function when receiving data depending on the nature of the data, such as an application automatically formatting data or generating a map when receiving address data, or the application automatically retrieving certain additional data depending on the identity of the user.

In some embodiments, a smart clipboard mechanism includes data access control or data handling control (or both) 135 utilizing metadata 150 that is collected for the copy and paste operation. The metadata 150, may include, but is not limited to, information regarding the identity of the user and information regarding the data to be transferred. In some embodiments, metadata for a data element stored on a smart clipboard may include, but is not limited to, a name of a user, a user status, and a confidentiality indicator for the data. In some embodiments, the metadata may further include other personal data regarding the user or information regarding the data being copied, such as data that may be used to establish preferences of the user or preferences for a receiving application. Examples may include information about the user that can assist in establishing preferences, or information such as address information that can be applied by the receiving application to fashion the use of the data in such application, such as to use a special application or function (such as mapping website or function) with such data.

In some embodiments, a smart clipboard mechanism or function is to utilize the metadata for data access control to determine whether the copying of data is authorized, wherein the determine of authorization may include determining whether persons who will have access to the copied data are authorized to view the data or whether the application to receive the copied data should receive such data; or for data handling control to determine how the copied data is to be utilized in the second location; or for both. In some embodiments, the metadata may be applied to provide personal preferences for the user.

In some embodiments, upon metadata being captured, the data may be used immediately or during the paste operation, depending on the nature of the operation. An example of immediate use may be when an address is copied, wherein the copy algorithm may detect the address, and presents inquiry with the menu of: Take me there (taxi), take me there (Uber™/Lyft™), make this my shipping address, or other address usages.

When the data is pasted in, for example, a Google™/Lyft/Uber application, the smart clipboard may then request the preferences of the user, and upon granting, dispatch the trip to the driver who, for example, speaks a particular language.

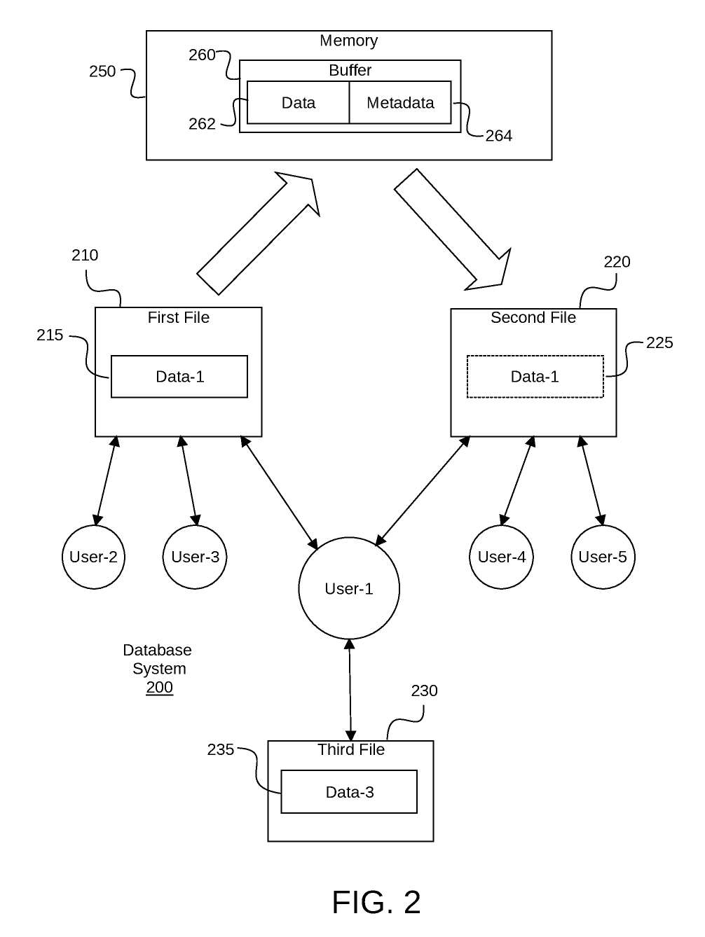

FIG. 2 is an illustration of a smart clipboard mechanism according to some embodiments. In some embodiments, a smart clipboard mechanism includes a memory structure providing for storage of both data to be copied and metadata associated with the data to be copied. As illustrated in FIG. 2, the smart clipboard mechanism may include a buffer 260 or other reserved portion of a memory 250, wherein the buffer 260 is a split clipboard that is operable to store clipboard metadata in addition to the clipboard data to be copied. As illustrated, the buffer 260 includes a data portion (first clipboard portion) 262 for the storage of data to be copied and a metadata portion (second clipboard portion) 264 for the storage of metadata associated with data that is stored in the data portion 262. A particular set of clipboard data and associated clipboard metadata forms a data pair for use in pasting the data from the clipboard to a requested second location. In some embodiments, the second clipboard portion may be a different type of memory than the first clipboard portion, such as for purposes of providing security for certain information. In some embodiments, both the clipboard data and the clipboard metadata are applied in a subsequent paste operation.

In some embodiments, a user, such as User-1, may utilize a database system 200, wherein in an example User-1 may have multiple windows open for multiple files, which may include files in one or more applications. In this example, User-1 at a certain point in time may be accessing a first file 210 in a first window, a second file 220 in a second window, and a third file 230 in a third window. User-1 may request copying of data from a first location 215 of the first file 210, the data in this example being Data-1. User-1 may further request pasting of Data-1 in a second location 225 of second file 220.

However, User-1 may operate in an environment in which the transfer of data from a first location to a second location may result in issues regarding data security or improper data access. For example, User-1 may operate in a multi-user environment in which multiple users have access to a particular file, and wherein individual users have particular access levels. As illustrated in FIG. 1, the first file 210 may be jointly accessible to a first set of users, the first set of users including User-1, User-2, and User 3, and the second file 220 may be jointly accessible to a second set of users, the second set of users including User-1, User-4, and User-5. If, for example, the access to the first file 210 is limited to a higher security level than the second file 220, such as when access to the first file is limited to engineering and the access to the second file also includes marketing or customers, then the transfer of Data-1 to the second file 220 may be inappropriate.

In a particular example, a sharable document, such as a Quip™ document, may be meant to be developed by 3 people who are sharing the document. In this example, pages 1-3 of the document are marketing pages, pages 4-6 are sales pages, and pages 7-9 are engineering pages. A user who isn't in the engineering team may be prohibited from pasting a particular text into the sales part of the document. In some embodiments, the smart clipboard will prevent the paste operation based on the clipboard metadata associated with the clipboard data.

In some embodiments, permissions for data may vary based on implementation. One example may provide permissions ALL (for anyone, perhaps including customers); Company (anyone within the company or organization); ENG (limited to those in engineering); ENG-xx (only engineers working on a particular project to separate developments); PERS (only those who need data for personnel issues to protect private data); MGT (only those in management for data that regards company strategy). In some embodiments, another example is a code to designate personal information to separate personal information from work information, and thus to assist in preventing accidental disclosure of personal information when using a computing device for multiple purposes, working at home, working from a smart phone or other portable device, etc. It is very easy to mistakenly transfer data from an incorrect file, particularly if a clipboard allows storage of multiple data elements from multiple sources and thus the wrong item may be chosen from the clipboard. As illustrated in FIG. 2, the User-1 also has a third file 230 open in a separate window, with the third file also including, for example, Data-3 in a third location 235. If such data was earlier copied, User-1 could easily copy Data-3 to the second file 220 without being aware of the error.

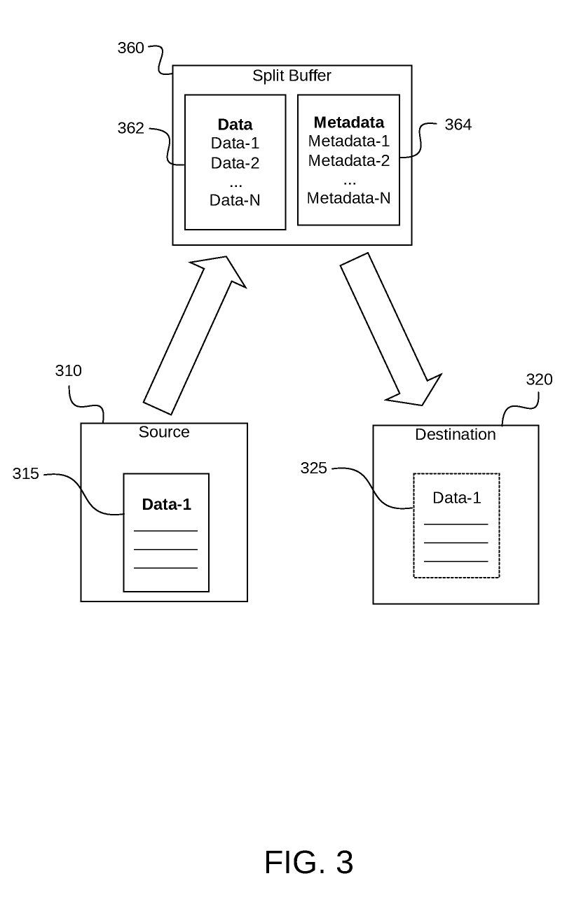

FIG. 3 is an illustration of a split clipboard buffer of a smart clipboard mechanism or process according to some embodiments. In some embodiments, a user such as the illustrated User-1 illustrated in FIG. 2, is operating in a database system and seeks to copy certain data, Data-1, from a first location 315 in a source 310 to a second location 325 in a destination 320. In some embodiments, the copy operation is performed utilizing a smart clipboard mechanism or process that includes a split buffer 360, the split buffer including a first portion 362 for the storage of data for copying and a second portion 364 for the storage of metadata associated with the data for copying.

In some embodiments, as illustrated in FIG. 3, the split buffer 360 of the smart clipboard may store multiple data elements, illustrated as Data-1, Data-2, and continuing through Data-N, and multiple metadata elements associated with the data elements, illustrated as Metadata-1 associated with Data-1, Metadata-2 associated with Data-2, and continuing through Metadata-N associated with Data-N. A data element and the metadata associated with such data element may together be referred to as a data-metadata pair, or data-metadata entry.

In some embodiments, upon receiving a request to copy Data-1 from first location 315, Data-1 and Metadata-1 are to be stored in the split buffer 360, and, upon receiving a request to paste Data-1 to location 2, Metadata-1 is utilized in data access control in determining whether to allow the paste operation, in data handling control in determining how to handle the paste operation for the data, or both. In some embodiments, Metadata-1 associated with Data-1 includes security information for Data-1, and the smart clipboard mechanism or process is to determine whether to allow the pasting of information based at least in part on the security information for the data and information regarding the destination. In some embodiments, metadata may include one or more of information regarding the user, information regarding the data copied to the clipboard, or information regarding the source of the copied data.

In an alternative embodiment, rather than utilizing a split buffer structure as illustrated in FIG. 3, a smart clipboard may include a buffer for the storage of clipboard data and clipboard metadata, wherein the storage of data further includes a header or other element to allow parsing of clipboard data and clipboard metadata from the clipboard. For example, upon receiving a request to copy a data element, a smart clipboard mechanism or process may include storage of a header, the data, and the associated metadata, wherein the header provides information to separate the data and associated metadata. In some embodiments, the clipboard metadata may be appended to the clipboard data on copy, and the clipboard metadata is then stripped from the clipboard data on paste. In an example, a clipboard data-metadata entry may be the following:
“CLIPBOARD_DATA” XXXMETADATAgender=male
   In some embodiments, a receiving “paste text( )” function would detect THE XXXMETADATA header and strip the metadata from the data, while internally adjusting the state of the destination window, such as, for example, a “gender” checkbox is toggled.

In some embodiments, during a paste operation, the destination may signal to the clipboard regarding whether the destination is capable of utilizing clipboard metadata to control how the clipboard data is handled in the paste operation. If the destination indicates that it can utilize such metadata, the clipboard will operate to copy data and metadata to the destination, and, if not, the clipboard will operate to copy only data to the destination.

In some embodiments, the destination may also signal to the clipboard regarding which chunks of metadata the destination wishes to receive. For example, the name of the user may not be useful for a translation program, but the gender of the user may be useful information as the correct translation of text may in certain circumstances depend on the gender of a party. In some embodiments, upon receiving identified metadata preferences from the destination, the clipboard apparatus or system may provide the selected metadata, or may provide am access control message to the user requesting permission to provide the selected metadata. For example, an access control message may include the following:
“The destination window requests access to certain metadata present in the clipboard. The information requested is: ‘User Gender’. Do you agree?”
   Upon approval the clipboard data and selected metadata are provided to the destination for use in controlling handling of the pasting of the data.

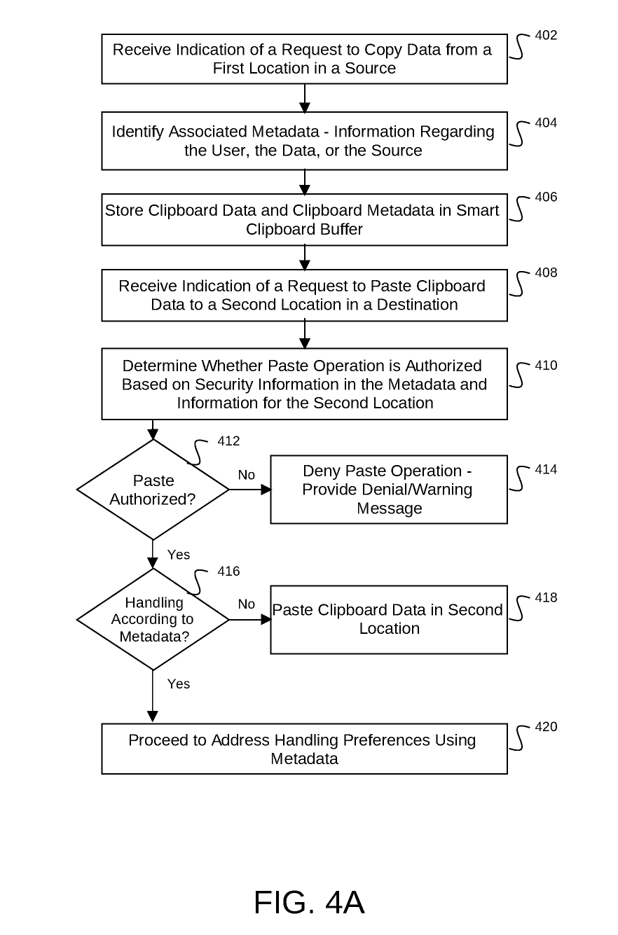

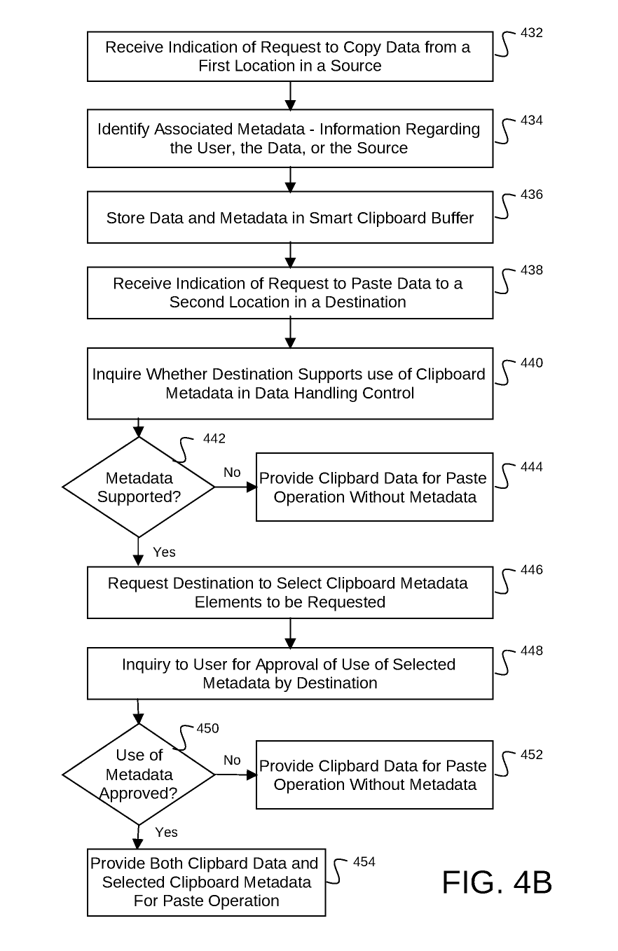

FIG. 4A is a flowchart to illustrate a smart clipboard process for secure data access control according to some embodiments. In some embodiments, an indication of a request may be received by an apparatus or system from a user to copy data from a first location in a source 402. The source may be, for example, a first file that is accessed using a first application. The request may be made by, for example, the user selecting the data by highlighting or otherwise indicating the desired data for copying, and the user selecting the copy through a menu selection or keystroke combination (e.g., Ctrl-C in a common combination). In some embodiments, the apparatus or system is to identify clipboard metadata associated with the selected clipboard data 404, wherein the clipboard metadata associated with the clipboard data may include, but is not limited to, information relating to the user, the identified data, or the source of the data. In some embodiments, the metadata includes security information, such as a permission level for access to data.

In some embodiments, clipboard data and associated clipboard metadata is stored in a smart clipboard buffer 406, wherein the smart clipboard buffer includes a first portion for storage of the clipboard data and a second portion for storage of the clipboard metadata associated with the clipboard data. While the particular example illustrated in FIG. 4A (or the example illustrated in FIG. 4B) regards the copying and pasting of a certain data element, in some embodiments the smart clipboard may store multiple elements for copy and paste operations. A clipboard data element and associated clipboard metadata (together being a data-metadata pair or data-metadata entry) may be removed from the clipboard buffer upon pasting, or the data-metadata entry may remain in the clipboard buffer until some action is taken to remove such entry, such as clearing the clipboard, or receiving more requests to copy than a maximum number of data-metadata entries for the clipboard, resulting in the removal of an entry (such as an oldest entry) from the clipboard.

Upon receiving an indication of a request to paste the data in the clipboard buffer to a second location 408, in some embodiments the apparatus or system is to determine whether to permit the paste operation based on the security information included in the metadata and information for the second location 410. In an example, the determination may include a comparison of a permission level for the user or a permission level for the data to a permission level for other persons having access the destination. In some embodiments, upon determining not to permit the paste operation 412, the apparatus or system is to at least initially deny the paste operation, and may provide a denial or warning message. In some implementation, the paste operation is not allowed to proceed, or an inquiry may be sent to the user regarding whether the paste operation is allowed to go forward.

In some embodiments, an apparatus or system may provide for clipboard data handling pursuant to clipboard metadata associated with the data in addition to providing for data security using metadata 416. If data handling according to associated clipboard metadata is not provided, the paste operation may proceed, with the data to be pasted in the second location of the destination 418. If data handling according to associated metadata is provided, such as illustrated in FIG. 4B, then the process may proceed with handling preferences for the clipboard data based at least in part on the clipboard metadata associated with the clipboard data 420.

FIG. 4B is a flowchart to illustrate a smart clipboard process for data handling control according to some embodiments. In some embodiments, the process for data handling control may follow a process for secure data access control, such as the process illustrated in FIG. 4A, or may be separate process. In some embodiments, an indication of a request may be received by an apparatus or system from a user to copy data from a first location in a source 432. The source may be, for example, a first file that is accessed using a first application. The request may be made by, for example, the user selecting the data by highlighting or otherwise indicating the desired data for copying, and the user selecting the copy through a menu selection or keystroke combination. In some embodiments, the apparatus or system is to identify metadata associated with the selected data 434, wherein the metadata associated with the data may include, but is not limited to, information regarding to the user, the identified data, or the source of the data.

In some embodiments, data and associated metadata are stored in a smart clipboard buffer 436, wherein the smart clipboard buffer includes a first portion for storage of the data to be copied and a second portion for storage of the metadata associated with the data to be copied.

Upon receiving an indication of a request to paste the data in the clipboard buffer to a second location in a destination 438, in some embodiments the smart clipboard apparatus or system is to inquire whether the destination supports the use of clipboard metadata in data handling control 440. Upon determining that the use of clipboard metadata is not supported 442, the clipboard apparatus or system is to provide the clipboard data without the associated clipboard metadata 444. Upon determining that the use of clipboard metadata is supported 442, the clipboard apparatus or system may further request the destination to select clipboard metadata elements that are to be requested 446.

The clipboard apparatus or system may then provide an inquiry to the user regarding whether the use of the selected metadata by the destination is approved 448. If use of the selected metadata is not approved 450, the clipboard apparatus or system may provide the clipboard data without the associated clipboard metadata 452. If use of the selected metadata is approved 450, the clipboard apparatus or system may provide both the clipboard data and the selected clipboard metadata to the destination for the paste operation 454.

The examples illustrating the use of technology disclosed herein should not be taken as limiting or preferred. This example sufficiently illustrates the technology disclosed without being overly complicated. It is not intended to illustrate all of the technologies disclosed. A person having ordinary skill in the art will appreciate that there are many potential applications for one or more implementations of this disclosure and hence, the implementations disclosed herein are not intended to limit this disclosure in any fashion.

One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

Other implementations may include a non-transitory computer readable storage medium storing instructions executable by a processor to perform a method as described above. Yet another implementation may include a system including memory and one or more processors operable to execute instructions, stored in the memory, to perform a method as described above.

Implementations may include:

In some embodiments, a smart clipboard apparatus includes a memory including a clipboard buffer, the clipboard buffer including storage of clipboard data and storage of clipboard metadata associated with the clipboard data. In some embodiments, upon receiving an indication of a request from a user to copy a set of data from a first location in a source, the apparatus is to store the set of data in the first portion of the clipboard buffer and is to store a set of metadata associated with the set of data in the second portion of the clipboard buffer, the set of metadata including security information for the set of data; and wherein, upon receiving an indication of a request from the user to paste the set of data to a second location in a destination, the apparatus uses the set of metadata to determine whether to permit pasting of the set of data to the second location based at least in part on the security information for the set of data and information regarding the destination.

In some embodiments, a machine-readable medium, such as a non-transitory computer-readable storage medium, carries one or more sequences of instructions for, upon receiving an indication of a request from a user to copy a set of data from a first location in a source, storing the set of data and a set of metadata associated with the set of data in a clipboard buffer, the set of metadata including security information for the set of data; and, upon receiving an indication of a request from the user to paste the set of data to a second location in a destination, determining whether to permit pasting of the set of data to the second location based at least in part on the security information for the set of data and information regarding the destination.

In some embodiments, a method for, receiving an indication of a request from a user to copy a set of data from a first location in a source, storing the set of data and a set of metadata associated with the set of data in a clipboard buffer, the set of metadata including security information for the set of data; and, upon receiving an indication of a request from the user to paste the set of data to a second location in a destination, determining whether to permit pasting of the set of data to the second location based at least in part on the security information for the set of data and information regarding the destination.

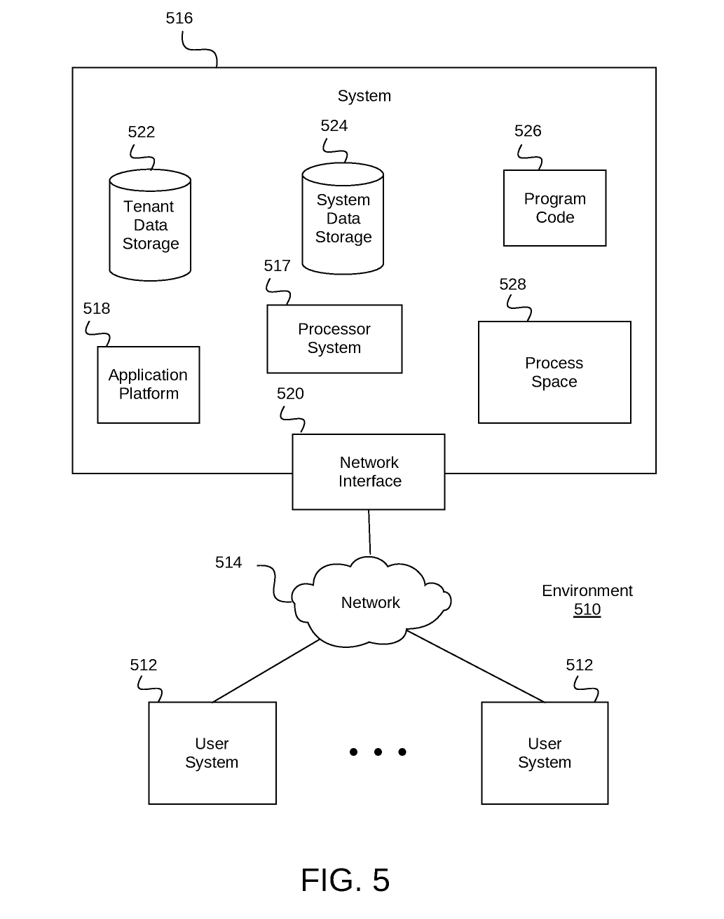

FIG. 5 illustrates a block diagram of an environment 510 wherein an on-demand database service might be used. In some embodiments, the environment may include a smart clipboard for secure data transfer. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

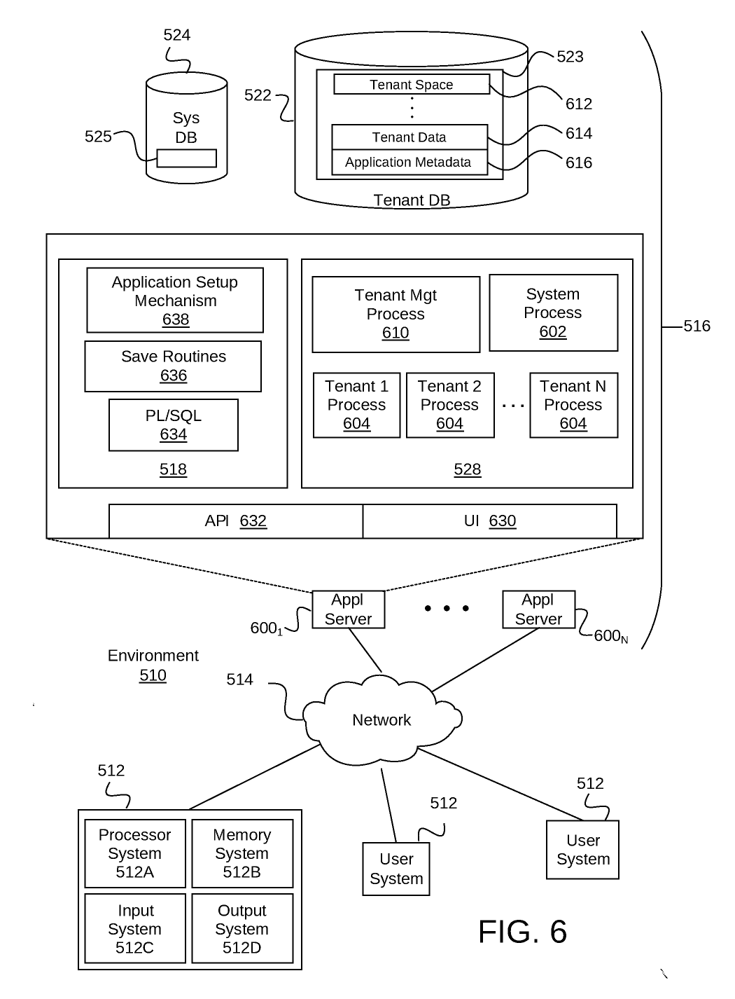

Environment 510 is an environment in which an on-demand database service exists. User system 512 may be any machine or system that is used by a user to access a database user system. For example, any of user systems 512 can be a handheld computing device, a mobile phone, a laptop computer, a work station, and/or a network of computing devices. As illustrated in herein FIG. 5 (and in more detail in FIG. 6) user systems 512 might interact via a network 514 with an on-demand database service, which is system 516.

An on-demand database service, such as system 516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third party application developers accessing the on-demand database service via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Core series processor or the like. Similarly, system 516 (and additional instances of an MTS, where more than one is present) and all of their components might be operator configurable using application(s) including computer code to run using a central processing unit such as processor system 517, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service” issued Jun. 1, 2010 to Craig Weissman, which is incorporated in its entirety herein for all purposes. Invocations to applications may be detected by one or more system processes, which manage retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 BIG-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While concepts been described in terms of several embodiments, those skilled in the art will recognize that embodiments not limited to the embodiments described, but can be practiced with modification and alteration within the spirit and scope of the appended claims. The description is thus to be regarded as illustrative instead of limiting.

1. A smart clipboard apparatus comprising:
a memory including a clipboard buffer, the clipboard buffer including storage of clipboard data and storage of clipboard metadata associated with the clipboard data, the clipboard buffer being a split buffer including a first clipboard portion to store the clipboard data and a second clipboard portion to store the clipboard metadata; and
a processor to process data and metadata for the clipboard buffer;
wherein, upon receiving an indication of a request from a user to copy a first set of data from a first location in a source, the apparatus stores the first set of data in the first clipboard portion of the clipboard buffer and a first set of metadata associated with the first set of data in the second clipboard portion of the clipboard buffer, the first set of metadata including security information for the first set of data; and
wherein, upon receiving an indication of a request from the user to paste the first set of data to a second location in a destination, the apparatus uses the first set of metadata from the second clipboard portion to determine whether to permit pasting of the first set of data from the first clipboard portion to the second location based at least in part on the security information for the first set of data contained in the metadata and information for the destination.

2. The apparatus of claim 1, wherein the security information includes a permission level for the user.

3. The apparatus of claim 1, wherein, upon determining not to permit the pasting of the first set of data to the second location, the apparatus provides a message indicating denial of the pasting of the first set of data.

4. The apparatus of claim 1, wherein, upon determining not to permit the pasting of the first set of data to the second location, the apparatus provides an inquiry to the user regarding whether the pasting of the first set of data to the second location should be allowed.

5-6. (canceled)

7. The apparatus of claim 1, wherein the first set of metadata may include one or more of information regarding the user, information regarding the first set of data, or information regarding the source of the first set of data.

8. The apparatus of claim 1, wherein, upon receiving the request from the user to paste the first set of data to the second location in the destination, the apparatus further utilizes the first set of metadata to determine how the first set of data is to be handled in the second location.

9. The apparatus of claim 8, wherein determining how the first set of data is to be handled in the second location includes sending an inquiry to the destination asking if the destination supports use of metadata in handling the pasting of data.

10. The apparatus of claim 8, wherein determining how the first set of data is to be handled in the second location includes sending an inquiry to the destination to select which metadata elements are requested.

11. The apparatus of claim 10, wherein the apparatus is further to send an inquiry to the user regarding whether use of the selected metadata elements is to be allowed.

12. A non-transitory computer-readable storage medium having stored thereon data representing sequences of instructions that, when executed by a processor, cause the processor to perform operations comprising:
receiving an indication of a request from a user of a computing system to copy a first set of data from a first location in a source, wherein the computing system includes a memory, the memory including a clipboard buffer, the clipboard buffer being a split buffer including a first clipboard portion to store clipboard data and a second clipboard portion to store clipboard metadata;
storing the first set of data in the first clipboard portion of the clipboard memory and storing a first set of metadata associated with the first set of data in the second clipboard portion of the clipboard buffer, the first set of metadata including security information for the first set of data;
receiving an indication of a request from the user to paste the first set of data to a second location in a destination; and
using the first set of metadata from the second clipboard portion to determine whether to permit pasting of the first set of data from the first clipboard portion to the second location based at least in part on the security information for the first set of data contained in the metadata and information for the destination.

13. The medium of claim 12, wherein the security information includes a permission level for the user.

14. The medium of claim 12, further comprising instructions that, when executed by the processor, cause the processor to perform operations comprising:
upon determining not to permit the pasting of the first set of data to the second location, providing a message indicating denial of the pasting of the first set of data.

15. The medium of claim 12, further comprising instructions that, when executed by the processor, cause the processor to perform operations comprising:
upon determining not to permit the pasting of the first set of data to the second location, providing an inquiry to the user regarding whether the pasting of the first set of data to the second location should be allowed.

16. (canceled)

17. The medium of claim 12, wherein the first set of metadata may include one or more of information regarding the user, information regarding the first set of data, or information regarding the source of the first set of data.

18. The medium of claim 12, further comprising instructions that, when executed by the processor, cause the processor to perform operations comprising:
upon receiving the indication of the request from the user to paste the first set of data to the second location in the destination, utilizing the first set of metadata to determine how the first set of data is to be handled in the second location.

19. The medium of claim 18, wherein determining how the first set of data is to be handled in the second location includes sending an inquiry to the destination asking if the destination supports use of metadata in handling the pasting of data.

20. The medium of claim 18, wherein determining how the first set of data is to be handled in the second location includes sending an inquiry to the destination to select which metadata elements are requested.

21. The medium of claim 20, further comprising instructions that, when executed by the processor, cause the processor to perform operations comprising:
sending an inquiry to the user regarding whether use of the selected metadata elements is to be allowed.

22. A system comprising:
data storage for system data and tenant data;
a processor system to process data for the system;
a network interface to provide connection with one or more user systems; and
a memory including a clipboard buffer, the clipboard buffer including storage of clipboard data and storage of clipboard metadata associated with the clipboard data, the clipboard buffer being a split buffer including a first clipboard portion to store the clipboard data and a second clipboard portion to store the clipboard metadata;
wherein, upon receiving an indication of a request from a user to copy a first set of data from a first location in a source, the system stores the first set of data in the first clipboard portion of the clipboard buffer and a first set of metadata associated with the first set of data in the second clipboard portion of the clipboard buffer, the first set of metadata including security information for the first set of data, the security information including a permission level for the user; and
wherein, upon receiving an indication of a request from the user to paste the first set of data to a second location in a destination, the system uses the first set of metadata from the second clipboard portion to determine whether to permit pasting of the first set of data from the first clipboard portion to the second location based at least in part on the security information for the first set of data contained in the metadata and information for the destination.

23. (canceled)

24. The system of claim 22, wherein the first set of metadata may include one or more of information regarding the user, information regarding the first set of data, or information regarding the source of the first set of data.

25. The system of claim 22, wherein, upon receiving the request from the user to paste the first set of data to the second location in the destination, the system further utilizes the first set of metadata to determine how the first set of data is to be handled in the second location.

26. The apparatus of claim 1, wherein the first clipboard portion includes a first type of memory and the second clipboard portion includes a second type of memory, the second type of memory being different than the first type of memory.

27. The apparatus of claim 26, wherein the second clipboard portion provides security for at least a portion of the metadata.

28. The medium of claim 12, wherein the first clipboard portion includes a first type of memory and the second clipboard portion includes a second type of memory, the second type of memory being different than the first type of memory.

29. The system of claim 22, wherein the first clipboard portion includes a first type of memory and the second clipboard portion includes a second type of memory, the second type of memory being different than the first type of memory.
